(19) United States
(12) Patent Application Publication
(10) Pub. No.: US 2016/0160446 A1
(43) Pub. Date: Jun. 9, 2016

(54) IMPREGNATING MATERIALS FOR RELEASE PAPERS

(71) Applicant: KURARAY EUROPE GMBH, Hattersheim (DE)

(72) Inventors: Samuel MICHEL, Mainz (DE); Eva DUDEK, Hohheim (DE)

(21) Appl. No.: 14/900,847

(22) PCT Filed: Jul. 4, 2014
(86) PCT No.: PCT/EP2014/064314

§ 371 Date: Dec. 22, 2015

(30) Foreign Application Priority Data
Jul. 10, 2013 (DE) 10 2013 107 329.8

(51) Int. Cl. D21H 19/32; D21H 27/00; C09D 183/10

(52) U.S. Cl. CPC D21H 19/32; C09D 183/10; D21H 27/001

(57) ABSTRACT

Release coatings on cellulosic substrates such as paper or cardboard, having high mechanical properties, are produced by coating with a polyvinyl alcohol containing ethylenic unsaturation and a silicone crosslinking agent and a silicone containing ethylenic unsaturation.

### CROSS REFERENCE TO RELATED APPLICATIONS

This application is the U.S. National Phase of PCT Appln. No. PCT/EP2014/064314 filed Jul. 4, 2014, which claims priority to German Application No. 10 2013 107 329.8 filed Jul. 10, 2013, the disclosures of which are incorporated in their entirety by reference herein.

### BACKGROUND OF THE INVENTION

1. Field of the Invention

The invention relates to a method for impregnating surfaces, particular paper, using polyvinyl alcohol that contains olefinic double bonds.

2. Description of the Related Art

In order to produce what are known as release papers, it has long been known to provide paper carriers with a silicone layer, whereby these paper carriers obtain dehesive properties.

The direct application of the silicone layers to the paper carrier, i.e. directly to the cellulose fibres, is difficult and leads to unsatisfactory release properties. Since most papers contain polyvinyl alcohol as a primer, and the binding of the silicone layer to these polymers is easier, a range of methods for siliconisation of paper surfaces via polyvinyl alcohol have already been established for this purpose.

EP 1625254 A1 proposes, for this purpose, reacting a silane-containing polyvinyl alcohol with a vinyl-terminated polysiloxane and an H-containing siloxane. The silane-containing polyvinyl alcohol contains Si groups in the main chain of the polymer and is obtainable from the copolymerisation of one or more vinyl esters with a silane-containing olefinically unsaturated monomer. A disadvantage of this method is that the silane-containing polyvinyl alcohol is more complex to produce and the silicone oil binds to this primer not via chemical interactions, but via physical interactions (hydrogen bridges). As a result, the impregnating layer is mechanically inadequate.

It is known from WO 2009/147283 A1 to use acetalised polyvinyl alcohols with Si groups in a side chain as impregnation agents. Such silane-containing polyvinyl acetals are obtainable by acetalisation of polyvinyl alcohol with suitably silane-substituted ketones or aldehydes. The production of silane-modified aldehydes or ketones is very complex and the reaction thereof with polyvinyl alcohol, in particular polyvinyl alcohols already introduced into paper, is difficult. This silane-modified polyvinyl alcohol is reacted with cross-linking agents and silicone oil via hydrogen bridge bonds, such that a coating that likewise is mechanically unsatisfactory results here as well.

### SUMMARY OF THE INVENTION

The object was therefore to provide a method for impregnating surfaces, in particular for producing release papers, that delivers mechanically and chemically stable coatings and avoids the preparation of silane-modified polyvinyl alcohols. It has surprisingly been found that polyvinyl alcohols can be provided with olefinically unsaturated C—C double bonds and that these double bonds can be used for the chemical binding of siloxane cross-linking agents. With this method it is possible to impregnate surfaces, to which such a modified polyvinyl alcohol has been applied, with siloxane compounds, which in particular for paper surfaces, leads to what are known as release papers.

### DETAILED DESCRIPTION OF THE PREFERRED EMBODIMENTS

The present invention therefore relates to an impregnation agent, obtainable by reacting polyvinyl alcohol that contains olefinic C—C double bonds with a silane-group-containing cross-linking agent and a silicone compound that contains olefinic C—C double bonds.

The reaction is catalysed in particular by platinum, palladium, or rhodium salts or complexes. Complexes of platinum and olefins are preferably used, since the reaction can be catalysed therewith at room temperature. Platinum complexes that contain nitrogen compounds such as pyridine, benzonitrile or benzotriazole catalyse the reaction at increased temperature.

The polyvinyl alcohol preferably contains the olefinic C—C double bonds in the main chain. Compounds of this type are obtainable for example by thermal treatment of polyvinyl alcohol. Polyvinyl alcohol with olefinic C—C double bonds in the main chain are offered under the type name Poval L8, L9 or L10 by Kuraray Europe GmbH.

Compounds of general formula I are preferably used:

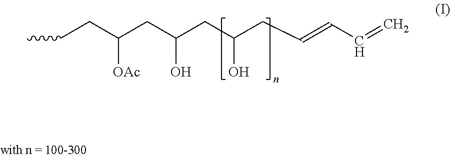

Alternatively, the polyvinyl alcohol may contain olefinic C—C double bonds in side chains. Compounds of this type are obtainable by copolymerisation of vinyl acetate with divinyl ethers, for example in accordance with the following reaction equation:

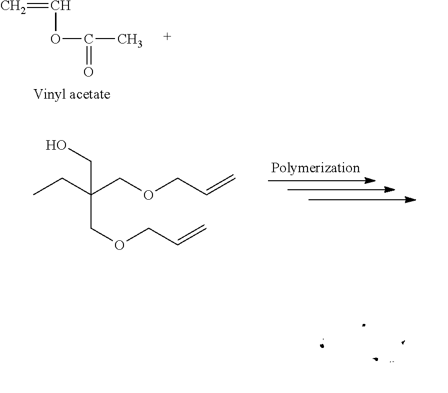

In both variants the degree of hydrolysis of the polyvinyl alcohols is 90-99 mol % and the proportion of olefinic C—C double bonds is 0.01-5% mol %.

Compounds of the general formula II are preferably used in the impregnation agent according to the invention as silane-group-containing cross-linking agents

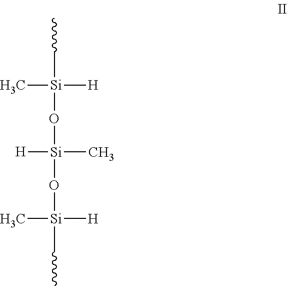

Compounds of general formula III are preferably used in the impregnation agent according to the invention as silicone compound that contains olefinic C—C double bonds:

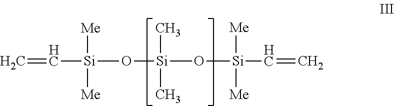

The reaction of the silicone compound that contains olefinic C—C double bonds with the silane-group-containing cross-linking agent leads to an intermediate product, sketched by way of example in general formula IV

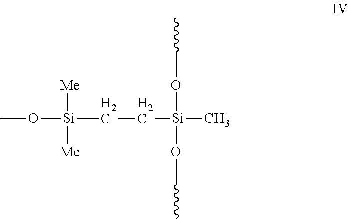

This intermediate product is then reacted with the polyvinyl alcohol that contains olefinic C—C double bonds to form the impregnation agent, sketched by way of example in general formula V.

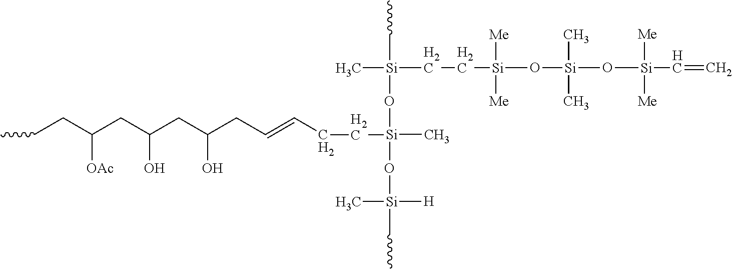

Preferred substrates for the method according to the invention are cellulose-based materials consisting of paper or cardboard.

The present invention also relates to a method for impregnating cellulose-based material by applying an impregnation agent, obtainable by reacting polyvinyl alcohol that contains olefinic C—C double bonds with a silane-group-containing cross-linking agent and a silicone compound that contains olefinic C—C double bonds.

The method according to the invention is preferably carried out such that the polyvinyl alcohol that contains olefinic C—C double bonds is applied to a cellulose-based material and is then reacted with a silane-group-containing cross-linking agent and a silicone compound that contains olefinic C—C double bonds.

All variants described for the impregnation agent can also be used in the method according to the invention.

### EXAMPLES

The polyvinyl alcohols were dissolved in a steam dissolution station at 98° C. for approximately 40 minutes and then filtered in order to remove any undissolved particles.

Commercially available 80g/m² papers were provided with a base coat formed of K-Control-Coater K202 from Erikson. The PVA solutions were then applied by means of doctor blade and the coated paper was dried twice at 130° C. with a drying band from Dow. The paper was then dried subsequently at 120° C. for 2 minutes in a drying cabinet in order to determine the weight per unit area. The coated papers were pre-smoothed using an iron press for 1 minute at 100° C. The paper was then rehumidified at 50° C. and 85% relative humidity for 24 hours in order to then be calendered at 1.8 kN/cm 80° C. with 2 nips.

The paper thus obtained was siliconised in a laboratory procedure. When producing the blend, care must be taken with regard to the dosing sequence. The papers were siliconised using a K-Control Coater K202 from Erikson by means of Meyer rod.

In order to set the desired weight per unit area, the silicone mixture was diluted using a suitable solvent (ICP solvent CAS 64742-47-8). The paper was sent twice through the dry section at 168 ° C. The weight per unit area was then determined after drying (at 120° C. for 2 minutes in a drying cabinet).

Papers having the following coatings were produced:

| Test | Composition |
|---|---|
| A | 100 GT Mowiol 15-99, polyvinyl alcohol from |
| | Kuraray Europe GmbH without olefinic double |
| | bonds, not according to the invention |
| B | 100 GT KRE-509, polyvinyl alcohol from Kuraray |
| | Europe GmbH with 0.35 mol % olefinic double |
| | bonds and a degree of polymerisation of 1000, |
| | according to the invention |
| C | 100 GT Mowiol 15-99 |
| | 100 GT Silicoleas Resin 11362 |
| | 5 GT Silicoleas cross-linking agent 12031 |
| | 5 GT Silicoleas catalyst 12070 |
| D | 100 GT KRE-509 |
| | 100 GT Silicoleas Resin 11362 |
| | 5 GT Silicoleas cross-linking agent 12031 |
| | 5 GT Silicoleas catalyst 12070 |

The amount of silicone applied was 2 or 3 g/m².

The papers now provided with the top coat were smoothed using an iron press for 1 minute at 100° C.

The first “rub off” test was performed immediately following the ironing. The paper was then stored at 23° C. and 50% relative atmospheric humidity, and the test was carried out after 1 day, 1 week and then weekly for 8 weeks.

The test was carried out as follows:

The silicone film was rubbed using a finger 10 times; the pressure should be selected such that the finger heats up considerably. Damage to the silicone coating manifested itself in the form of rubbed-off crumbs (rub off) and at matt points (smear) when the tested paper was viewed under an inclined light source.

Table 1 shows that a mechanically significant silicone anchoring is obtained with polyvinyl alcohols that contain olefinic double bonds. This leads to a considerable improvement of the rub-off and therefore of the adhesion of the silicone to the paper.

As additional assessment of the mechanical stress of the paper surface, the tested surface was treated with PVA detection reagents (iodine-iodine-potash solution) in order to come to a conclusion regarding the stability of the silicone anchoring via the staining intensity of the paper. The more mechanically stable is the silicone coating, the more is the polyvinyl alcohol base coat covered and the less is the staining.

Table 2 shows that the polyvinyl alcohols used in accordance with the invention enable a mechanically much more resistant silicone anchoring.

TABLE 1

| | immedi- | 1 | 1 | 2 | 3 | 4 | 5 | 6 | 7 | 8 | 9 |
|---|---|---|---|---|---|---|---|---|---|---|---|
| Test | ately | day | week | weeks | weeks | weeks | weeks | weeks | weeks | weeks | weeks |
| A | 1 | 1 | 1 | 1 | 1 | 1 | 1 | 1 | 1 | 1 | 1 |
| B | 1 | 1 | 1 | 1 | 1 | 1 | 1 | 1 | 1 | 1 | 1 |
| C 2 | 1 | 1 | 1 | 1 | 1 | 1 | 2 | 2 | 3 | 3 | 3 |
| C 3 | 1 | 1 | 1 | 1 | 1 | 1 | 2 | 2 | 3 | 3 | 3 |
| D 2 | 1 | 1 | 1 | 1 | 1 | 1 | 1 | 1 | 1 | 1 | 1 |
| D 3 | 1 | 1 | 1 | 1 | 1 | 1 | 1 | 1 | 1 | 1 | 1 |

1 = hardly any rub off,
2 = little rub off,
3 = heavy rub off

TABLE 2

| | immedi- | 1 | 1 | 2 | 3 | 4 | 5 | 6 | 7 | 8 | 9 |
|---|---|---|---|---|---|---|---|---|---|---|---|
| Test | ately | day | week | weeks | weeks | weeks | weeks | weeks | weeks | weeks | weeks |
| A | 3 | 3 | 3 | 3 | 3 | 3 | 3 | 3 | 3 | 3 | 3 |
| B | 3 | 3 | 3 | 3 | 3 | 3 | 3 | 3 | 3 | 3 | 3 |
| C 2 | 1 | 1 | 1 | 1 | 1 | 1 | 2 | 2 | 3 | 3 | 3 |
| C 3 | 1 | 1 | 1 | 1 | 1 | 1 | 2 | 2 | 3 | 3 | 3 |
| D 2 | 1 | 1 | 1 | 1 | 1 | 1 | 1 | 1 | 1 | 1 | 1 |
| D 3 | 1 | 1 | 1 | 1 | 1 | 1 | 1 | 1 | 1 | 1 | 1 |

1 = no staining,
2 = slight staining,
3 = heavy staining

1.-10. (canceled)

11. An impregnation agent, obtained by a process comprising reacting polyvinyl alcohol containing olefinic C—C double bonds with a silane-group-containing cross-linking agent and a silicone compound that contains olefinic C—C double bonds.

12. The impregnation agent of claim 11, wherein the polyvinyl alcohol contains olefinic C—C double bonds in a main chain of the polyvinyl alcohol.

13. The impregnation agent of claim 11, wherein compounds of the Formula I are used as a polyvinyl alcohol containing olefinic C—C double bonds 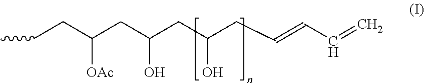
with n=100-3000.

14. The impregnation agent of claim 11, wherein the polyvinyl alcohol contains olefinic C—C double bonds in side chains.

15. The impregnation agent of claim 11, wherein compounds of the Formula II are used as silane-group-containing cross-linking agents

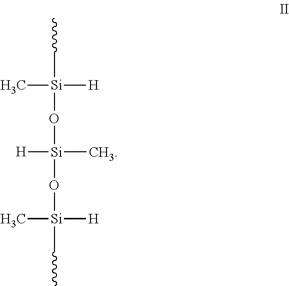

16. The impregnation agent of claim 11, wherein compound of Formula III is used as a silicone compound containing olefinic C—C double bonds:

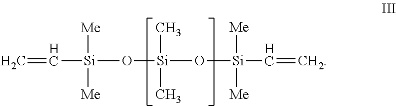

17. A method for impregnating cellulose-based materials, comprising:
applying an impregnation agent, obtained by reacting at least one polyvinyl alcohol containing olefinic C—C double bonds with a silane-group-containing cross-linking agent and a silicone compound that contains olefinic C—C double bonds.

18. The method of claim 17, wherein at least one polyvinyl alcohol containing olefinic C—C double bonds is applied to a cellulose-based material, and is then reacted with a silane-group-containing cross-linking agent and a silicone compound that contains olefinic C—C double bonds.

19. The method of claim 17, wherein the reaction is catalysed by platinum, palladium, or rhodium salts or complexes.

20. The method of claims 17, wherein paper or cardboard is used as cellulose-based material.
